(19) United States
(12) Patent Application Publication
(10) Pub. No.: US 2016/0125115 A1
(43) Pub. Date: May 5, 2016

(54) GENERATING AN ELECTROMAGNETIC PARAMETERIZED CELL FOR AN INTEGRATED CIRCUIT DESIGN

(71) Applicant: International Business Machines Corporation, Armonk, NY (US)

(72) Inventors: Sue E. Strang, Burlington, VT (US); Hung H. Tran, Hopewell Junction, NY (US); Wayne H. Woods, JR., Burlington, VT (US); Ze Zhang, Essex Junction, VT (US)

(21) Appl. No.: 14/533,148

(22) Filed: Nov. 5, 2014

(51) Int. Cl. G06F 17/50

(52) U.S. Cl. CPC G06F 17/5045; G06F 17/505; G06F 17/5009

(57) ABSTRACT

An electromagnetic parameterized cell (EM Pcell) is generated for a local environment of an integrated circuit (IC) design for an electronic design flow. A set of parasitics extracted netlists is developed from a set of Pcell layouts and an external EM environment. The parasitics extracted netlists are simulated to provide a set of performance metrics. When a symbolic view of the EM Pcell is displayed to a designer during a subsequent schematic phase of the design flow, the performance metrics are accessed from a design library, to increase accuracy of parameter value selection for the EM Pcell without a parasitics extraction of the physical layout and generation of a parasitics extracted netlist.

### BACKGROUND

1. Field of the Invention

The present disclosure relates to generating an electromagnetic (EM) parameterized cell (Pcell) for use in a schematic design phase of an integrated circuit (IC) design.

2. Description of Related Art

In conventional electronic design flow, a designer uses a suite of software design tools to progress from a high level of logical abstraction to a detailed physical representation of an integrated circuit (IC) design that is optimized for manufacture. After defining abstract behavior of the desired IC, the designer translates an abstract logical language to a discrete netlist of logic gates. Based on the netlist of logic gates, the designer uses a cell-based schematic capture tool to generate a bottom-up cell-based schematic of the IC design.

Following the schematic design phase, simulation of the cell-based schematic may provide an indication of logical functionality of the IC design, but cannot provide an accurate simulation of performance metrics, e.g., timing delays, for a manufacturable IC design. An accurate simulation of the digital and analog performance metrics of a cell-based IC design requires a physical design, including a schematic-driven layout that exactly places all circuit components and routes all interconnects to minimize power and timing delays.

In a nanometer-scaled IC, an aspect of the physical design includes a parasitics extraction of the physical layout of the cell-based IC design and generation of corresponding parasitics extracted netlists. The parasitics extraction is required because the small distances between the base layers of a cell and a neighboring electromagnetic (EM) field source increase electromagnetic susceptibility, affecting cell performance. A major purpose of automatic parasitics extraction, including extraction of parasitic capacitances, parasitic resistances and parasitic inductances, is to create an accurate analog model of the cell-based IC design, so that simulations of the parasitics extracted netlists can emulate actual digital and analog performance metrics of a manufacturable cell-based IC design. The results of the digital simulations can be used to populate cell-based design libraries for signal delay and loading calculations, such as, timing analyses and signal integrity analyses, while analog test benches can determine whether the extracted parasitics will allow the IC design to meet desired performance metrics.

Typically, many iterative simulations of the physical IC design are needed to achieve sign-off for a nanometer-scaled IC design. During the design flow, any change to the physical layout of the cell-based circuit design requires an iterative parasitics extraction of the electronic components and interconnects, and an iterative generation of corresponding parasitics extracted netlists. These iterative parasitics extractions of the electronic components and interconnects, and iterative generations of corresponding parasitics extracted netlists are costly in both time and computational resources.

There remains a need to increase the computational efficiency and accuracy of an electronic design flow of a cell-based IC design, where performance of a cell can be affected by a neighboring EM field source.

### SUMMARY

In view of the foregoing, the disclosure may provide a method to increase the computational efficiency and accuracy of an electronic design flow of a cell-based integrated circuit (IC) design, where performance of a cell can be affected by a neighboring electromagnetic (EM) field source. The method may include generating an electromagnetic parameterized cell (EM Pcell) for a local environment of an IC design for a subsequent schematic phase of an electronic design flow, where the local environment consists of base layers of the EM Pcell that are susceptible to EM fields generated by an external EM environment. The method may also include instantiating a set of parameter values of a parameterized cell (Pcell) to produce a set of Pcell layouts corresponding to a set of local environment layouts. The method may further include developing a set of parasitics extracted netlists from the set of local environment layouts and a layout of the external EM environment. The method may yet further include simulating the set of parasitics extracted netlists to provide a set of performance metrics corresponding to each of the set of local environment layouts. The method may yet further include storing the set of parasitics extracted netlists and the set of performance metrics in a design library and creating a symbolic view of the EM Pcell corresponding to the set of local environment layouts. Finally, the method may include accessing the set of performance metrics from the design library during the subsequent schematic phase of the electronic design flow, when the symbolic view of the EM Pcell is displayed to a designer by a user interface.

The disclosure may also provide a system to increase the computational efficiency and accuracy of an electronic design flow of a cell-based integrated circuit (IC) design, where performance of a cell can be affected by a neighboring electromagnetic (EM) field source. The system may include a memory of an IC design library for a suite of software design tools that stores parasitics extracted netlists and performance metrics of an electromagnetic parameterized cell (EM Pcell); and a processor for the suite of software design tools that: generates the EM Pcell for a local environment of an IC design for a subsequent schematic phase of an electronic design flow, the local environment consisting of base layers of the EM Pcell that are susceptible to EM fields generated by an external EM environment; instantiates a set of parameter values of a parameterized cell (Pcell) to produce a set of Pcell layouts corresponding to a set of local environment layouts; develops a set of parasitics extracted netlists from the set of local environment layouts and a layout of the external EM environment; simulates the set of parasitics extracted netlists to provide a set of performance metrics corresponding to each of the set of local environment layouts; creates a symbolic view of the EM Pcell corresponding to the set of local environment layouts; and accesses the set of performance metrics from the design library during the subsequent schematic phase of the electronic design flow, when the symbolic view of the EM Pcell is displayed to a designer by a user interface.

The disclosure may provide a computer program product to improve computational efficiency and accuracy of simulations of a cell-based design of an integrated circuit (IC), the computer program product comprising a computer readable storage medium having program code embodied therewith, the program code being readable/executable by a computer to perform a method comprising: generating an electromagnetic parameterized cell (EM Pcell) for a local environment of an IC design for a subsequent schematic phase of an electronic design flow, the local environment consisting of base layers of the EM Pcell that are susceptible to electromagnetic (EM) fields generated by an external EM environment; instantiating a set of parameter values of a parameterized cell (Pcell) to produce a set of Pcell layouts corresponding to a set of local environment layouts; developing a set of parasitics extracted netlists from the set of local environment layouts and a layout of the external EM environment; simulating the set of parasitics extracted netlists to provide a set of performance metrics corresponding to each of the set of local environment layouts; storing the set of parasitics extracted netlists and the set of performance metrics in a design library and creating a symbolic view of the EM Pcell corresponding to the set of local environment layouts; and accessing the set of performance metrics from the design library during the subsequent schematic phase of the electronic design flow, when the symbolic view of the EM Pcell is displayed to a designer by a user interface.

### BRIEF DESCRIPTION OF THE SEVERAL VIEWS OF THE DRAWINGS

The methods of the disclosure herein will be better understood from the following detailed description with reference to the drawings, which are not necessarily drawn to scale and in which:

FIG. 1 is a schematic diagram illustrating the relation of a design library to a schematic cell view, a symbolic cell view, a physical layout cell view and an extracted parasitics netlist of embodiments herein;

FIG. 2 is a schematic diagram illustrating a master parameterized cell (Pcell) of a transistor with instantiations of changes to a length of a gate in the transistor, to a number of gates in the transistor, and to a width of the gate of the transistor of embodiments herein;

FIG. 3 is a schematic diagram illustrating local environment layouts that contain a schematic of a Pcell and an external electromagnetic (EM) environment of embodiments herein;

FIG. 4 is a flowchart 400 illustrating a method of for improving computational during a subsequent schematic phase of the design flow 1 efficiency and accuracy in a cell-based design flow of embodiments herein;

FIG. 5 is a schematic diagram of a hardware system according to embodiments herein;

FIG. 6 is a schematic diagram of a computing environment according to embodiments herein;

FIG. 7 is a schematic diagram of a functional abstract layers according to embodiments herein;

FIG. 8 is a schematic diagram of a deployment system according to embodiments herein;

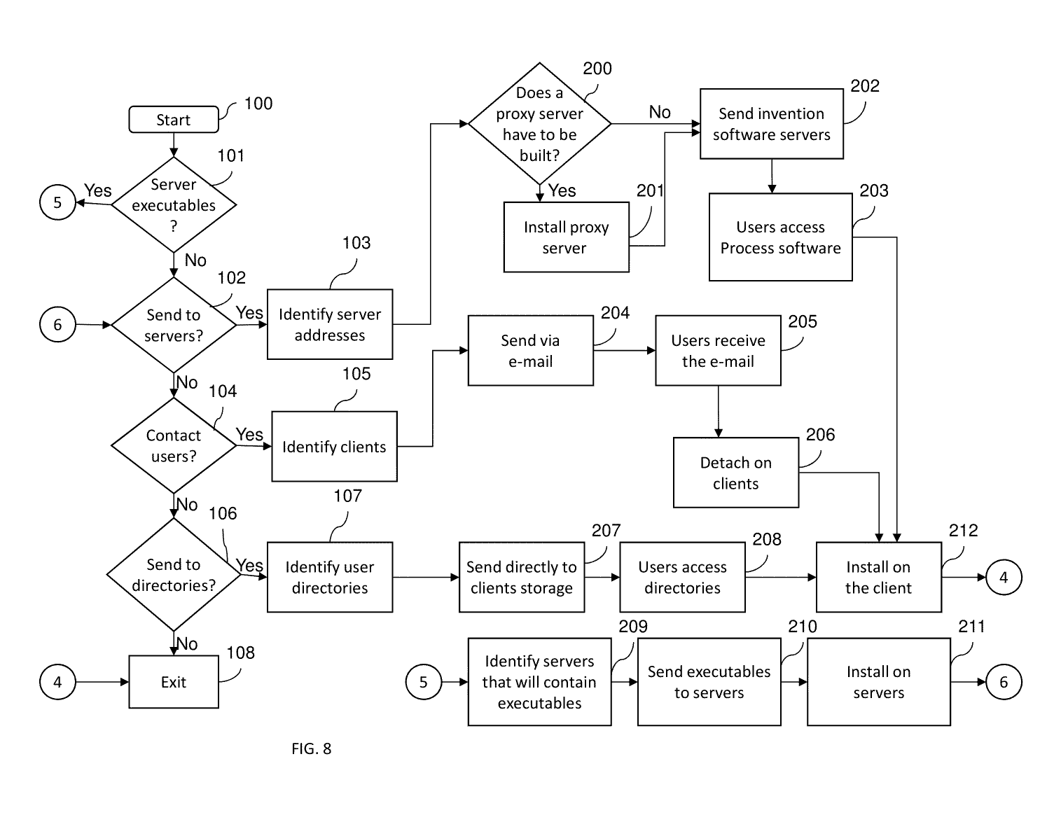

FIG. 9 is a schematic diagram of an integration system according to embodiments herein;

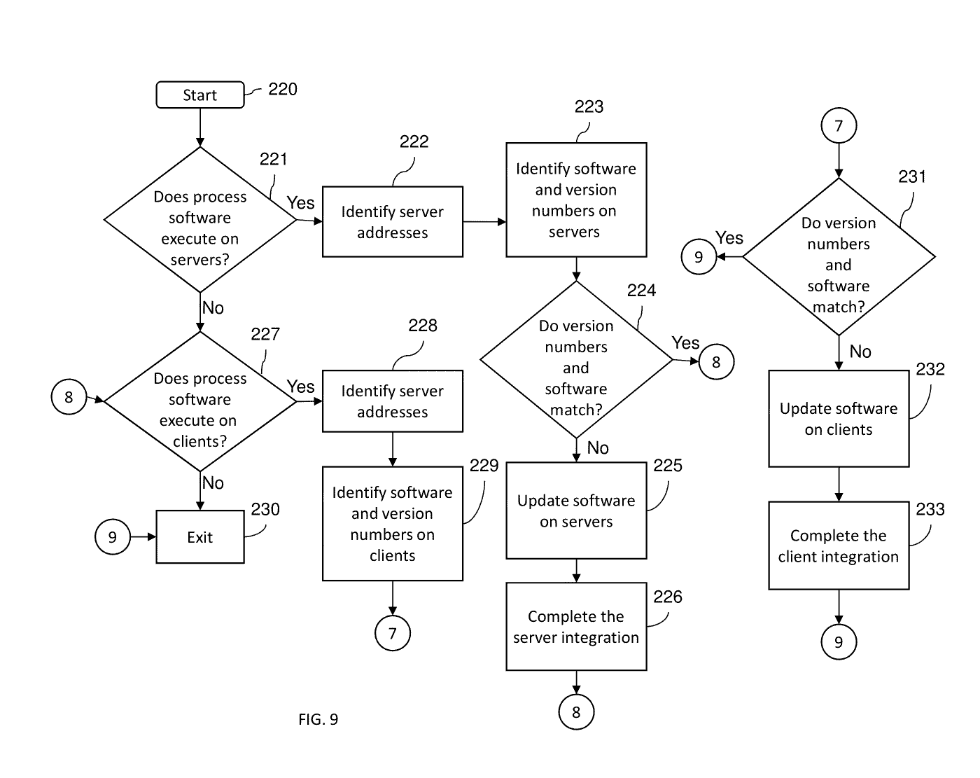

FIG. 10 is a schematic diagram of an on demand system according to embodiments herein;

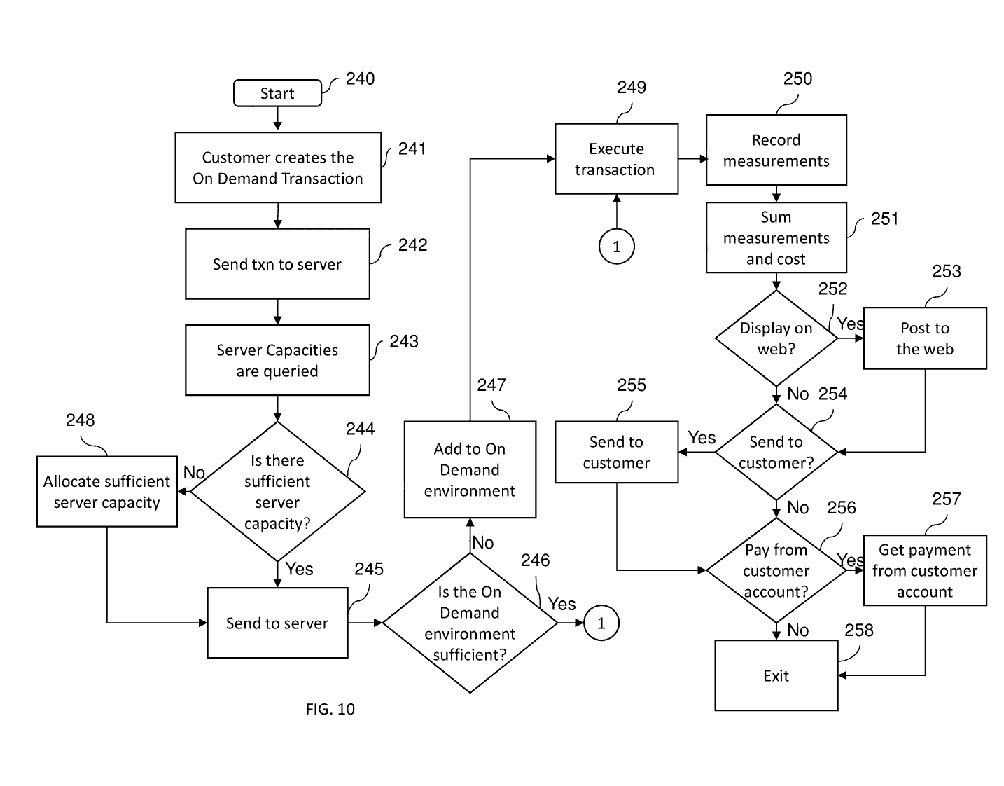

FIG. 11 is a schematic diagram of a virtual private network system according to embodiments herein; and

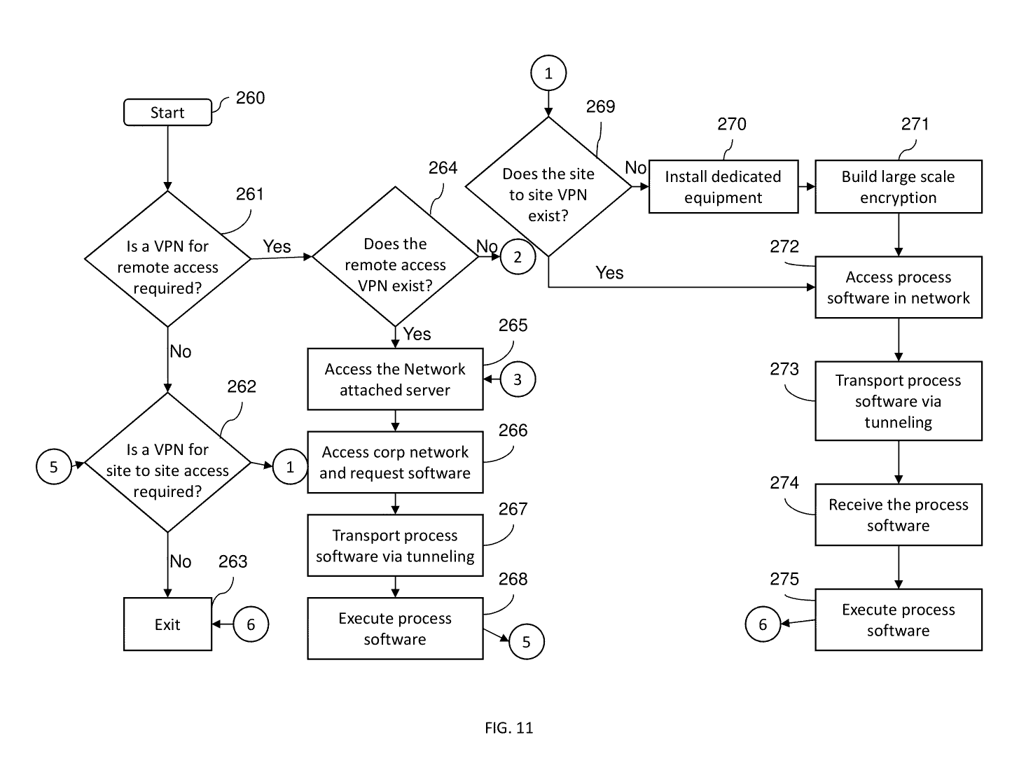

FIG. 12 is a schematic diagram of a virtual private network system according to embodiments herein.

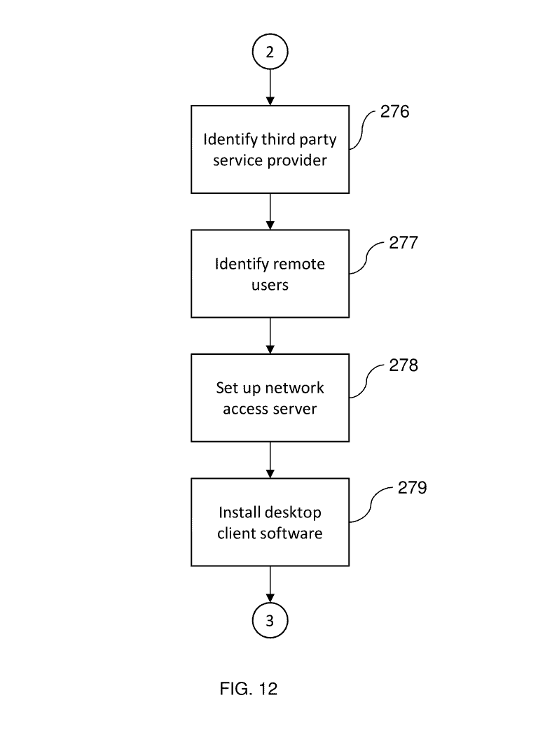

### DETAILED DESCRIPTION

The exemplary aspects of the disclosure and its various features and advantageous details are explained more fully with reference to the non-limiting exemplary aspects that are illustrated in the accompanying drawings and detailed in the following description. It should be noted that the features illustrated in the drawings are not necessarily drawn to scale. Descriptions of well-known materials, components, and processing techniques are omitted so as to not unnecessarily obscure the exemplary methods, systems, and products of the disclosure. The examples used herein are intended to merely facilitate an understanding of ways in which the exemplary aspects of the disclosure may be practiced and to further enable those of skill in the art to practice the exemplary aspects of the disclosure. Accordingly, the examples should not be construed as limiting the scope of the exemplary aspects of the disclosure.

As stated above, the disclosure may describe increasing the computational efficiency and accuracy of an electronic design flow of a cell-based IC design, where performance of a cell can be affected by a neighboring electromagnetic (EM) field source.

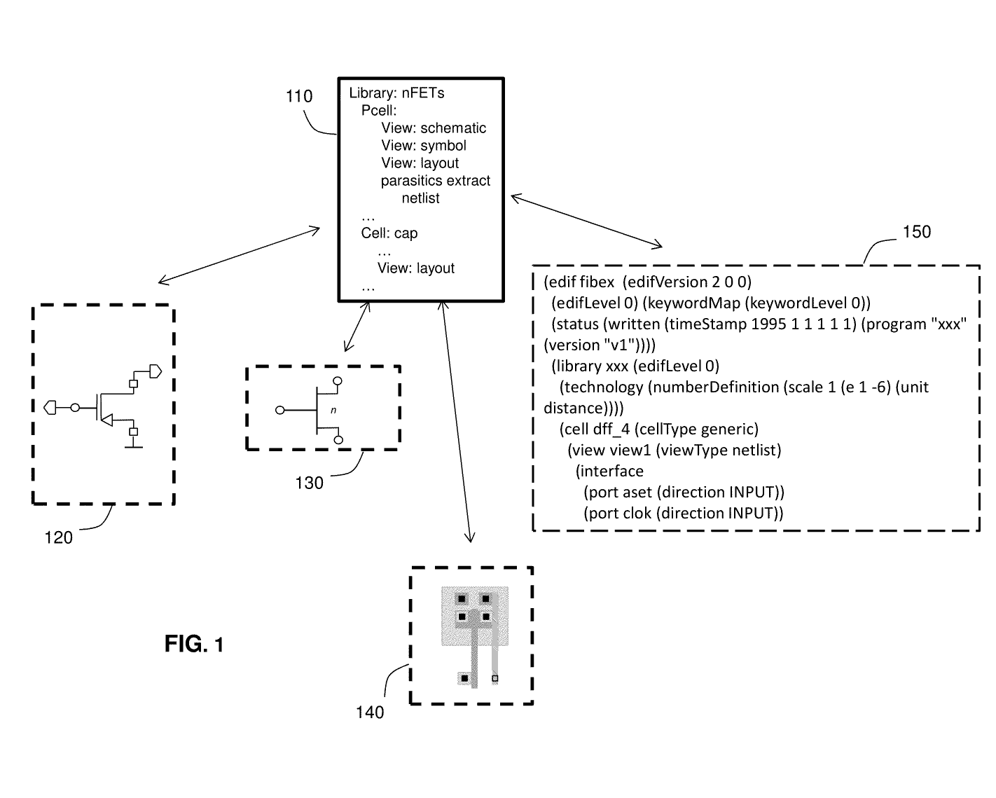

Referring to FIG. 1, an electronic design library 110 embodies a software directory that contains cells, as software subdirectories, which in turn may contain a schematic view 120, a symbolic view 130, a layout view 140, and a parasitics extracted netlist 150, as data files. Each library may contain a catalog of cells and their views, along with paths described by programming language text connecting each cell to all of its data files. The design library may be associated with a technology file that supplies the mask layer maps, color maps, design rules and extraction parameters required to view, design, simulate, and fabricate a cell-based IC design in an electronic design flow. Each cell in the design library uses the same mask layers, colors, design rules, parameter values and symbolic devices associated with the technology file.

In conventional electronic design flow, the schematic design phase of an IC may represent electronic devices as cells. Electronic devices may include basic devices and hierarchical devices. Basic devices may include any of diodes, transistors, contacts, interconnects, capacitors, inductors, and resistors. Interconnects may include vias and wires. Diodes, transistors and contacts may be located in the base layers of a cell, while interconnects, capacitors, inductors and resistors may be located in the overlying interconnect layers of the cell. However, a capacitor, e.g., a deep trench capacitor, or a resistive element may also be located in the base layers of a cell. The cells of these basic devices may be connected, one to the other, to form a hierarchical cell representing a hierarchical device, e.g., an inverter, of a cell-based IC design.

The initial design of a cell for an electronic device may be created in a schematic view 120 of the cell. Designers may simulate the performance of the electronic device from the schematic view 120 of the cell, based on an automatically extracted netlist. The extracted netlist is a nodal description of the cell including: connections between nodes of the cell, and connections of the nodes to terminals external to the cell. After verifying the netlist of the schematic view 120, the schematic view of the electronic device may then be stored in a design library 110, along with the netlist. At this time, a symbolic view 130 of the cell for the electronic device may also be created and stored in the design library 110. Rather than creating a new schematic view and symbolic view for each iteration of a design or for a new design, the designer may access the design library 110 to call a stored schematic view 120 or symbolic view 130 of an electronic device.

From a manufacturing perspective, the cell's layout view 140 may represent a physical “manufacturing blueprint” of the cell. The physical layout may be organized into base layers, i.e., Front End of Line (FEOL) layers, corresponding to, for example, the different structures of a field effect transistor, and into interconnect layers, i.e., the Back End of Line (BEOL) layers, which may join the contacts of the cell to other cells, to power, or to ground.

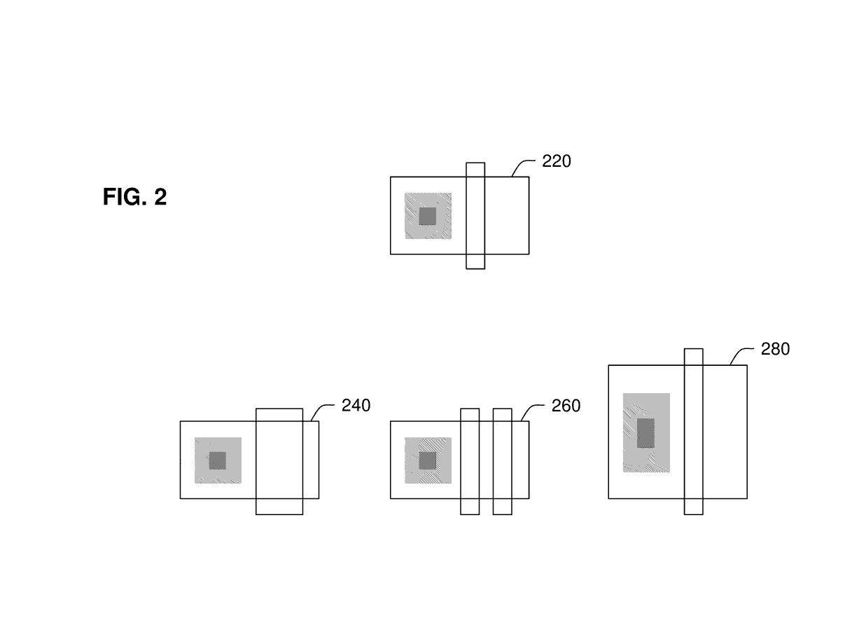

Referring to FIG. 2, a parameterized cell, or Pcell, is a graphic programmable cell of a basic or hierarchical device that may be customized for each instance by a layout editor in a design flow. The designer may edit an existing physical layout view of a cell by adding parameter definitions to create the Pcell. For example, a master Pcell 220 of a transistor can be created, in which parameters are assigned to define instances of the transistor having: a greater gate length 240, a repeated gate 260, and a greater gate width 280. Each instance of the Pcell may be represented graphically in a physical layout view of precise dimensions and placement. A symbolic view of the Pcell may also be created and stored in the design library. Pcells may also be created and instantiated by a Pcell programming language.

A set of parameter values for the Pcell may each be instantiated to produce a set of Pcell layouts for an IC design. For example, a number of Pcell layouts may be instantiated across an input range of parameter values, e.g., 40 nm, 60 nm, 80 nm, and 100 nm of gate width, where each instantiation yields a physical Pcell layout corresponding to a single parameter value.

In the schematic phase, a Pcell in the cell-based schematic of the IC design may be identified by the designer as being susceptible to EM fields generated by an EM source external to the base layers of the Pcell, i.e., the local environment layout of the Pcell. An external EM environment layout, relative to the local environment layout of the Pcell, may include an EM field source in any of: an interconnect layer overlying the base layers of the Pcell, an interconnect layer of a neighboring cell, and base layers of a neighboring cell.

An automatic parasitics extraction tool may calculate the parasitic effects for each of the set of Pcell layouts, corresponding to each of the set of parameter values, for the base layers of each of the set of Pcell layouts, i.e., a set of local environment layouts. The automatic parasitics extraction may also encompass an external EM environment layout. A set of parasitics extracted netlists may then be developed from the set of local environments, corresponding to each of the set of Pcell layouts, and the layout of the external EM environment.

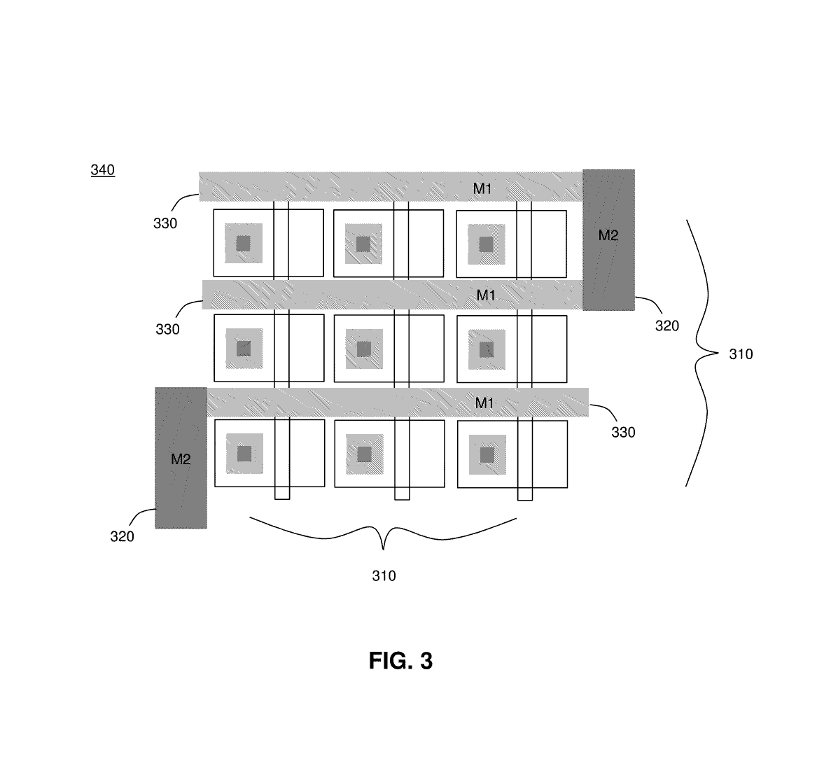

Referring to FIG. 3, an exemplary schematic view of a portion of schematic design of an IC 340 may comprise: a 3×3 array of Pcells 310, where the local environment of each Pcell represents the base layers of a field effect transistor; and the external EM environment represents an M1 metal interconnect 330 that overlies a portion of a gate of each of the Pcells, and an M2 metal interconnect 320 that is in proximity to some of the gates of some of the 3×3 array of Pcells 310. In this example, it may be expected that the local environment of a first Pcell located at the upper right corner of the 3×3 array of Pcells may be susceptible to greater EM fields, i.e., the external EM environment, than that of a second Pcell located in the lower right corner of the 3×3 array of Pcells, because the first Pcell is physically close to two M1 interconnects and one M2 interconnect that may generate EM fields, while the second Pcell is close to but one M1 interconnect that may generate EM fields.

The set of parasitics extracted netlists may be simulated to provide a set of performance metrics corresponding to each of the set of local environment layouts of the Pcell that may be susceptible to an external EM field source, i.e., an external EM environment. The performance metrics may include any of: signal propagation delay, rise and fall times, skew, power consumption, power loss and frequency domain parameters. Thus, the various performance metrics of the set of EM Pcell layouts, corresponding to of each of the set of parameter values for the EM Pcell, may be viewed in relation to the EM fields generated by a neighboring basic or hierarchical device, i.e., the external EM environment. For example, transistor gates of a greater width may perform differently than transistor gates of a lesser width to electromagnetic fields generated by an overlying edge of large planar capacitor. Similarly, various EM fields generated by different external EM environments may provide different performance metrics for a local environment of the EM Pcell. For example, the EM fields generated by a single large capacitor in the external EM environment may affect a performance metric of the EM Pcell of a transistor differently than an array of smaller capacitors formed in the external EM environment, because of the different fringe effects of the EM fields generated by the single large capacitor versus the array of smaller capacitors, the different field strengths, and the different geometries.

The designer may then store the extracted parasitics netlists and the set of performance metrics, corresponding to each of the local environment layouts of the EM Pcell, in the design library. A symbolic cell view may be created that visually distinguishes an EM Pcell for which a set of extracted parasitics netlists and a set of performance metrics have been stored in the design library 110. The symbolic view of the visually distinguishable EM Pcell may be displayed to the designer during a subsequent schematic phase of a design flow, when the designer selects a Pcell from the design library 110.

During a subsequent schematic phase of a design flow, the designer may, for example, access the stored performance metrics of an EM Pcell in the design library to review nominal, best, and worst case performance metric values, including signal propagation delay, rise and fall times, skew, power consumption, power loss and frequency domain parameters, as relates to the various parameter values of the EM Pcell, without a parasitics extraction of the physical layout and generation of a parasitics extracted netlist. A sweep across the input range of the EM Pcell parameter values in the local environment may provide the performance metric as a function of the input range of Pcell parameter values to the designer via a user interface. Review of the stored performance metric values of EM Pcells, in the schematic phase, may permit the designer to select an optimal EM Pcell and possibly, parameter values of the EM Pcell that are likely provide the desired performance metrics for the IC design without a parasitics extraction of the physical layout and generation of a parasitics extracted netlist; thus, increasing the computational efficiency and accuracy of simulations of a cell-based design of an IC in a schematic phase of an electronic design flow, where performance of a cell can be affected by a neighboring electromagnetic (EM) field source.

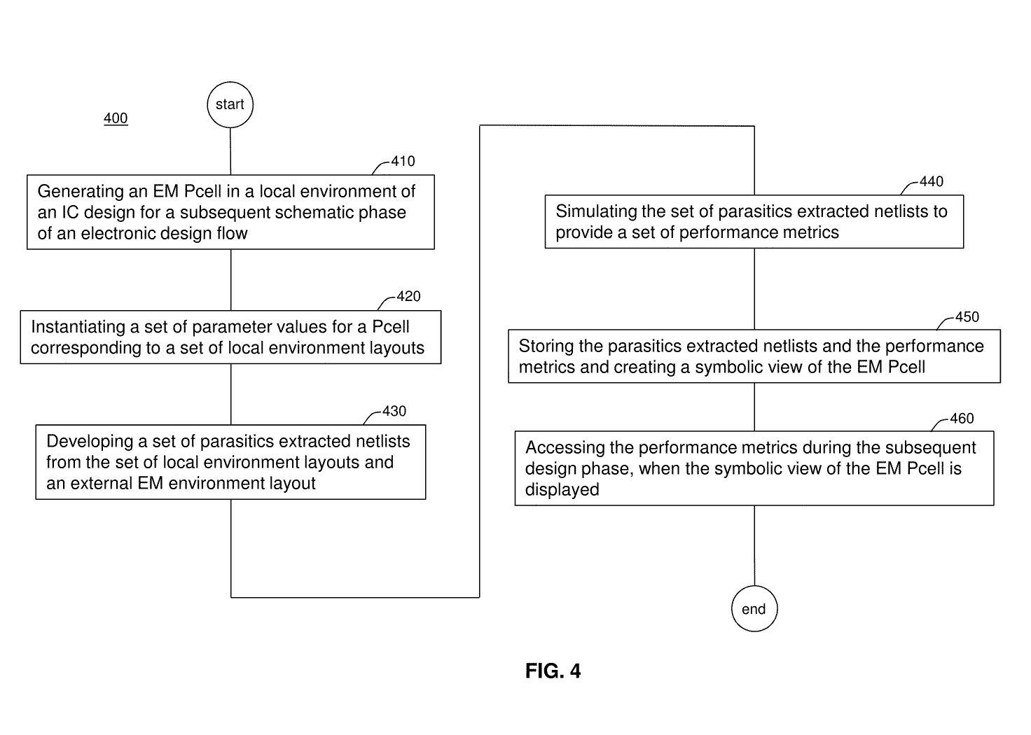

FIG. 4 illustrates a flow chart 400 of a method for increasing the computational efficiency and accuracy of simulations of a cell-based design of an IC in a schematic phase of an electronic design flow, where performance of a cell can be affected by a neighboring electromagnetic (EM) field source, without greatly increasing the costs of simulation. The method may include generating an EM (electromagnetic) parameterized cell (Pcell) for a local environment of an integrated circuit (IC) design for a subsequent schematic phase of an electronic design flow, the local environment consisting of base layers of the EM Pcell that are susceptible to EM fields generated by an external EM environment 410. The method may also include instantiating a set of parameter values of a Pcell to produce a set of Pcell layouts corresponding to a set of local environment layouts 420. The method may further include developing a set of parasitics extracted netlists from the set of local environment layouts and a layout of the external EM environment 430. The method may yet further include simulating the set of parasitics extracted netlists to provide a set of performance metrics corresponding to each of the set of local environment layouts 440. The method may further include storing the set of parasitics extracted netlists and the set of performance metrics in a design library and creating a symbolic view of the EM Pcell corresponding to the set of local environment layouts 450. Finally, the method may include accessing the set of performance metrics from the design library during the subsequent schematic phase of the electronic design flow, when the symbolic view of the EM Pcell is displayed to a designer by a user interface 460.

In the above method, the external EM environment may include at least one of: at least one of a basic device and an interconnect in an interconnect layer of the EM Pcell; at least one of a basic device and an interconnect in an interconnect layer of a neighboring cell to the EM Pcell; and at least one of a basic device and a hierarchical device in base layers of a neighboring cell to the EM Pcell. The basic device may include any of a diode, a transistor, a contact, a capacitor, an inductor, and a resistor. The interconnect may include any of a via and a wire. The hierarchical device may include at least two basic devices.

In the above method, the set of performance metrics may include any of: a set of signal propagation delays, a set of rise and fall times, a set of signal skews, a set of power consumptions, a set of power losses, and a set of frequency domain parameters.

The above method may further comprise flattening each of the set of local environment layouts to develop the set of parasitic s extracted netlists. The above method may further comprise mapping each of the nominal, best, and worst case of performance metric values to an input range of the parameter values instantiated by the EM Pcell; sweeping the input range of the parameter values of the EM Pcell to provide a sweep of the performance metric values that are stored and generating a display of the sweep on a user interface for review by a designer; and determining from the sweep, one of the input range of the parameter values that yields an optimal performance metric value that approximates a sign-off value of the performance metric for the IC design.

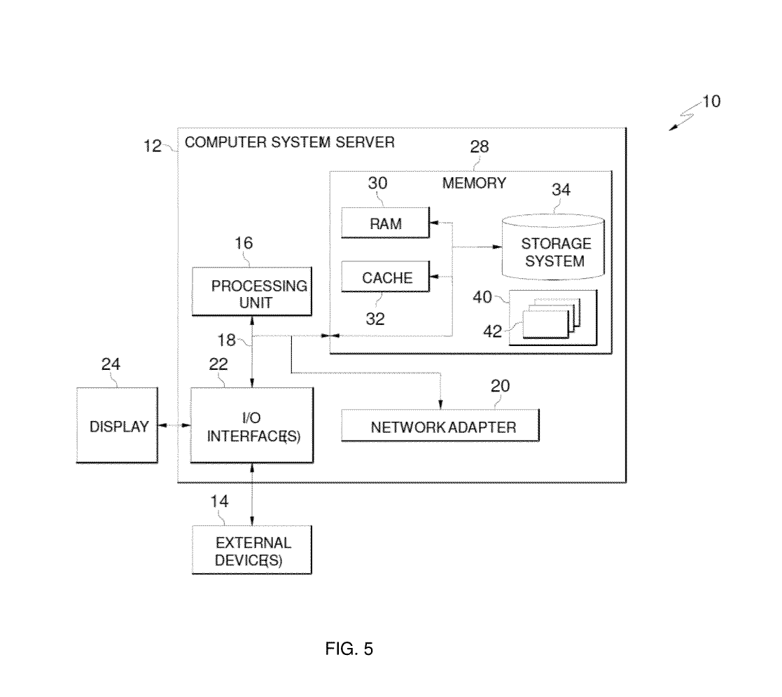

FIG. 5 illustrates a computer system for improving computational efficiency and accuracy of an electronic design flow of a cell-based IC design, where performance of a cell can be affected by a neighboring EM field source. The computer system may include a memory 14, 16 that stores parasitics extracted netlists and performance metrics of an EM Pcell; and a CPU 10 that generates an EM (electromagnetic) parameterized cell (Pcell) for a local environment of an integrated circuit (IC) design for a subsequent schematic phase of an electronic design flow, the local environment consisting of base layers of the EM Pcell that are susceptible to EM fields generated by an external EM environment; instantiates a set of parameter values of a Pcell to produce a set of Pcell layouts corresponding to a set of local environment layouts; develops a set of parasitics extracted netlists from the set of local environment layouts and a layout of the external EM environment; simulates the set of parasitics extracted netlists to provide a set of performance metrics corresponding to each of the set of local environment layouts; stores the set of parasitics extracted netlists and the set of performance metrics in a design library and creates a symbolic view of the EM Pcell corresponding to the set of local environment layouts; and accesses the set of performance metrics from the design library during the subsequent schematic phase of the electronic design flow, when the symbolic view of the EM Pcell is displayed to a designer by a user interface.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

In the on-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Software as a Service (SaaS): the capability provided to the consumer is to use the provider's applications running on a cloud infrastructure. The applications are accessible from various client devices through a thin client interface such as a web browser (e.g., web-based email). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for loadbalancing between clouds).

A cloud computing environment is service oriented with a focus on statelessness, low coupling, modularity, and semantic interoperability. At the heart of cloud computing is an infrastructure comprising a network of interconnected nodes.

Referring now to FIG. 5, a schematic of an example of a cloud computing node is shown. Cloud computing node 10 is only one example of a suitable cloud computing node and is not intended to suggest any limitation as to the scope of use or functionality of embodiments of the invention described herein. Regardless, cloud computing node 10 is capable of being implemented and/or performing any of the functionality set forth hereinabove.

In cloud computing node 10 there is a computer system/server 12, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, handheld or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 5, computer system/server 12 in cloud computing node 10 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the invention.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, device drivers, redundant processing units, external disk drive arrays, RAID systems, tape drives, and data archival storage systems, etc.

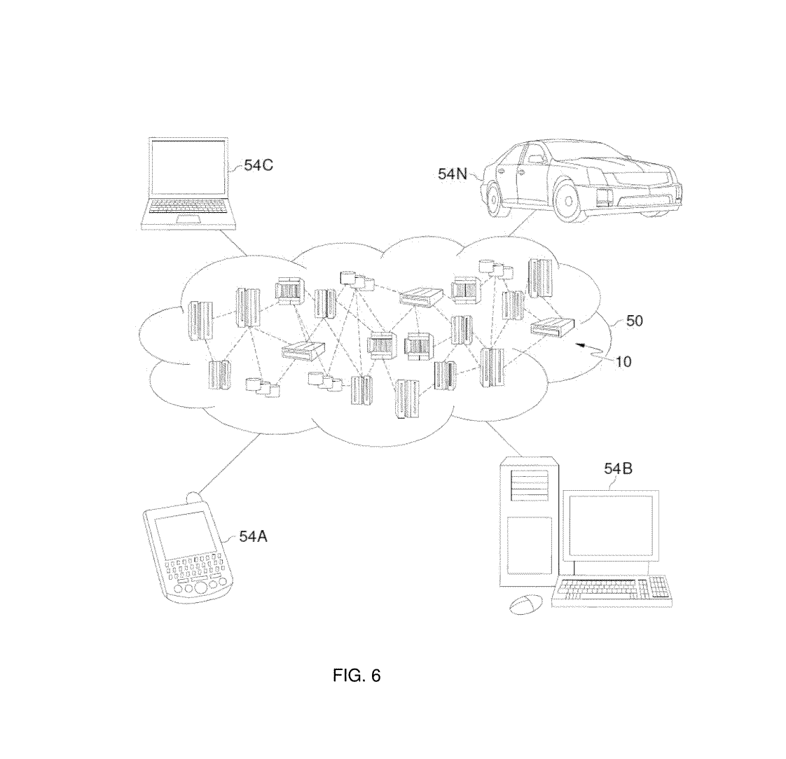

Referring now to FIG. 6, illustrative cloud computing environment 50 is depicted. As shown, cloud computing environment 50 comprises one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 2 are intended to be illustrative only and that computing nodes 10 and cloud computing environment 50 can communicate with any type of computerized device over any type of network and/or network addressable connection (e.g., using a web browser).

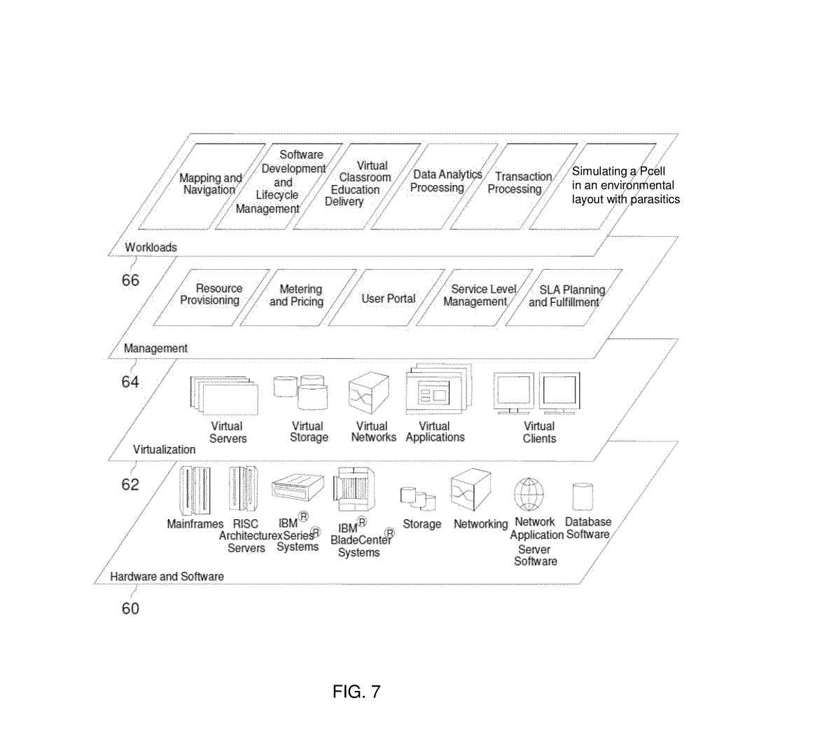

Referring now to FIG. 7, a set of functional abstraction layers provided by cloud computing environment 50 (FIG. 2) is shown. It should be understood in advance that the components, layers, and functions shown in FIG. 7 are intended to be illustrative only and embodiments of the invention are not limited thereto. As depicted, the following layers and corresponding functions are provided:

Hardware and software layer 60 includes hardware and software components. Examples of hardware components include mainframes, in one example IBM® zSeries® systems; RISC (Reduced Instruction Set Computer) architecture based servers, in one example IBM pSeries® systems; IBM xSeries® systems; IBM BladeCenter® systems; storage devices; networks and networking components. Examples of software components include network application server software, in one example IBM WebSphere® application server software; and database software, in one example IBM DB2® database software. (IBM, zSeries, pSeries, xSeries, BladeCenter, WebSphere, and DB2 are trademarks of International Business Machines Corporation registered in many jurisdictions worldwide).

Virtualization layer 62 provides an abstraction layer from which the following examples of virtual entities may be provided: virtual servers; virtual storage; virtual networks, including virtual private networks; virtual applications and operating systems; and virtual clients.

In one example, management layer 64 may provide the functions described below. Resource provisioning provides dynamic procurement of computing resources and other resources that are utilized to perform tasks within the cloud computing environment. Metering and Pricing provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal provides access to the cloud computing environment for consumers and system administrators. Service level management provides cloud computing resource allocation and management such that required service levels are met. Service Level Agreement (SLA) planning and fulfillment provide pre-arrangement for, and procurement of, cloud computing resources for which a future requirement is anticipated in accordance with an SLA.

Workloads layer 66 provides examples of functionality for which the cloud computing environment may be utilized. Examples of workloads and functions which may be provided from this layer include: mapping and navigation; software development and lifecycle management; virtual classroom education delivery; data analytics processing; transaction processing; and simulating a parameterized cell in a selected environmental layout with parasitics.

While it is understood that the process software may be deployed by manually loading directly in the client, server and proxy computers via loading a storage medium such as a CD, DVD, etc., the process software may also be automatically or semi-automatically deployed into a computer system by sending the process software to a central server or a group of central servers. The process software is then downloaded into the client computers that will execute the process software. Alternatively the process software is sent directly to the client system via e-mail. The process software is then either detached to a directory or loaded into a directory by a button on the e-mail that executes a program that detaches the process software into a directory. Another alternative is to send the process software directly to a directory on the client computer hard drive. When there are proxy servers, the process will, select the proxy server code, determine on which computers to place the proxy servers' code, transmit the proxy server code, then install the proxy server code on the proxy computer. The process software will be transmitted to the proxy server and then it will be stored on the proxy server.

Step 100 begins the deployment of the process software. The first thing is to determine if there are any programs that will reside on a server or servers when the process software is executed 101. If this is the case then the servers that will contain the executables are identified 209. The process software for the server or servers is transferred directly to the servers' storage via FTP or some other protocol or by copying though the use of a shared file system 210. The process software is then installed on the servers 211.

Next, a determination is made on whether the process software is be deployed by having users access the process software on a server or servers 102. If the users are to access the process software on servers then the server addresses that will store the process software are identified 103.

A determination is made if a proxy server is to be built 200 to store the process software. A proxy server is a server that sits between a client application, such as a Web browser, and a real server. It intercepts all requests to the real server to see if it can fulfill the requests itself. If not, it forwards the request to the real server. The two primary benefits of a proxy server are to improve performance and to filter requests. If a proxy server is required then the proxy server is installed 201. The process software is sent to the servers either via a protocol such as FTP or it is copied directly from the source files to the server files via file sharing 202. Another embodiment would be to send a transaction to the servers that contained the process software and have the server process the transaction, then receive and copy the process software to the server's file system. Once the process software is stored at the servers, the users via their client computers, then access the process software on the servers and copy to their client computers file systems 203. Another embodiment is to have the servers automatically copy the process software to each client and then run the installation program for the process software at each client computer. The user executes the program that installs the process software on his client computer 212 then exits the process 108.

In step 104 a determination is made whether the process software is to be deployed by sending the process software to users via e-mail. The set of users where the process software will be deployed are identified together with the addresses of the user client computers 105. The process software is sent via e-mail to each of the users' client computers. The users then receive the email 205 and then detach the process software from the e-mail to a directory on their client computers 206. The user executes the program that installs the process software on his client computer 212 then exits the process 108.

Lastly a determination is made on whether to the process software will be sent directly to user directories on their client computers 106. If so, the user directories are identified 107. The process software is transferred directly to the user's client computer directory 207. This can be done in several ways such as but not limited to sharing of the file system directories and then copying from the sender's file system to the recipient user's file system or alternatively using a transfer protocol such as File Transfer Protocol (FTP). The users access the directories on their client file systems in preparation for installing the process software 208. The user executes the program that installs the process software on his client computer 212 then exits the process 108.

The process software is integrated into a client, server and network environment by providing for the process software to coexist with applications, operating systems and network operating systems software and then installing the process software on the clients and servers in the environment where the process software will function.

The first step is to identify any software on the clients and servers including the network operating system where the process software will be deployed that are required by the process software or that work in conjunction with the process software. This includes the network operating system that is software that enhances a basic operating system by adding networking features.

Next, the software applications and version numbers will be identified and compared to the list of software applications and version numbers that have been tested to work with the process software. Those software applications that are missing or that do not match the correct version will be upgraded with the correct version numbers. Program instructions that pass parameters from the process software to the software applications will be checked to ensure the parameter lists match the parameter lists required by the process software. Conversely parameters passed by the software applications to the process software will be checked to ensure the parameters match the parameters required by the process software. The client and server operating systems including the network operating systems will be identified and compared to the list of operating systems, version numbers and network software that have been tested to work with the process software. Those operating systems, version numbers and network software that do not match the list of tested operating systems and version numbers will be upgraded on the clients and servers to the required level.

After ensuring that the software, where the process software is to be deployed, is at the correct version level that has been tested to work with the process software, the integration is completed by installing the process software on the clients and servers.

Step 220 begins the integration of the process software. The first thing is to determine if there are any process software programs that will execute on a server or servers 221. If this is not the case, then integration proceeds to 227. If this is the case, then the server addresses are identified 222. The servers are checked to see if they contain software that includes the operating system (OS), applications, and network operating systems (NOS), together with their version numbers that have been tested with the process software 223. The servers are also checked to determine if there is any missing software that is required by the process software 223.

A determination is made if the version numbers match the version numbers of OS, applications and NOS that have been tested with the process software 224. If all of the versions match and there is no missing required software the integration continues in 227.

If one or more of the version numbers do not match, then the unmatched versions are updated on the server or servers with the correct versions 225. Additionally if there is missing required software, then it is updated on the server or servers 225. The server integration is completed by installing the process software 226.

Step 227 which follows either 221, 224 or 226 determines if there are any programs of the process software that will execute on the clients. If no process software programs execute on the clients the integration proceeds to 230 and exits. If this not the case, then the client addresses are identified 228.

The clients are checked to see if they contain software that includes the operating system (OS), applications, and network operating systems (NOS), together with their version numbers that have been tested with the process software 229. The clients are also checked to determine if there is any missing software that is required by the process software 229.

A determination is made is the version numbers match the version numbers of OS, applications and NOS that have been tested with the process software 231. If all of the versions match and there is no missing required software, then the integration proceeds to 230 and exits.

If one or more of the version numbers do not match, then the unmatched versions are updated on the clients with the correct versions 232. In addition, if there is missing required software then it is updated on the clients 232. The client integration is completed by installing the process software on the clients 233. The integration proceeds to 230 and exits.

The process software is shared, simultaneously serving multiple customers in a flexible, automated fashion. It is standardized, requiring little customization and it is scalable, providing capacity on demand in a pay-as-you-go model.

The process software can be stored on a shared file system accessible from one or more servers. The process software is executed via transactions that contain data and server processing requests that use CPU units on the accessed server. CPU units are units of time such as minutes, seconds, hours on the central processor of the server. Additionally the accessed server may make requests of other servers that require CPU units. CPU units are an example that represents but one measurement of use. Other measurements of use include but are not limited to network bandwidth, memory usage, storage usage, packet transfers, complete transactions etc.

When multiple customers use the same process software application, their transactions are differentiated by the parameters included in the transactions that identify the unique customer and the type of service for that customer. All of the CPU units and other measurements of use that are used for the services for each customer are recorded. When the number of transactions to any one server reaches a number that begins to affect the performance of that server, other servers are accessed to increase the capacity and to share the workload. Likewise when other measurements of use such as network bandwidth, memory usage, storage usage, etc. approach a capacity so as to affect performance, additional network bandwidth, memory usage, storage etc. are added to share the workload.

The measurements of use used for each service and customer are sent to a collecting server that sums the measurements of use for each customer for each service that was processed anywhere in the network of servers that provide the shared execution of the process software. The summed measurements of use units are periodically multiplied by unit costs and the resulting total process software application service costs are alternatively sent to the customer and or indicated on a web site accessed by the customer which then remits payment to the service provider.

In another embodiment, the service provider requests payment directly from a customer account at a banking or financial institution.

In another embodiment, if the service provider is also a customer of the customer that uses the process software application, the payment owed to the service provider is reconciled to the payment owed by the service provider to minimize the transfer of payments.

Step 240 begins the On Demand process. A transaction is created than contains the unique customer identification, the requested service type and any service parameters that further specify the type of service 241. The transaction is then sent to the main server 242. In an On Demand environment the main server can initially be the only server, and then as capacity is consumed other servers are added to the On Demand environment.

The server central processing unit (CPU) capacities in the On Demand environment are queried 243. The CPU requirement of the transaction is estimated, then the server's available CPU capacity in the On Demand environment is compared to the transaction CPU requirement to see if there is sufficient CPU available capacity in any server to process the transaction 244. If there is not sufficient server CPU available capacity, then additional server CPU capacity is allocated to process the transaction 248. If there was already sufficient Available CPU capacity then the transaction is sent to a selected server 245.

Before executing the transaction, a check is made of the remaining On Demand environment to determine if the environment has sufficient available capacity for processing the transaction. This environment capacity consists of such things as but not limited to network bandwidth, processor memory, storage etc. 246. If there is not sufficient available capacity, then capacity will be added to the On Demand environment 247. Next the required software to process the transaction is accessed, loaded into memory, and then the transaction is executed 249.

The usage measurements are recorded 250. The usage measurements consist of the portions of those functions in the On Demand environment that are used to process the transaction. The usage of such functions as, but not limited to, network bandwidth, processor memory, storage and CPU cycles are what is recorded. The usage measurements are summed, multiplied by unit costs and then recorded as a charge to the requesting customer 251.

If the customer has requested that the On Demand costs be posted to a web site 252 then they are posted 253. If the customer has requested that the On Demand costs be sent via e-mail to a customer address 254 then they are sent 255. If the customer has requested that the On Demand costs be paid directly from a customer account 256 then payment is received directly from the customer account 257. The last step is exit the On Demand process.

Step 260 begins the Virtual Private Network (VPN) process. A determination is made to see if a VPN for remote access is required 261. If it is not required, then proceed to 262. If it is required, then determine if the remote access VPN exists 264.

If it does exist, then proceed to 265. Otherwise identify the third party provider that will provide the secure, encrypted connections between the company's private network and the company's remote users 276. The company's remote users are identified 277. The third party provider then sets up a network access server (NAS) 278 that allows the remote users to dial a toll free number or attach directly via a cable or DSL modem to access, download and install the desktop client software for the remote-access VPN 279.

After the remote access VPN has been built or if it been previously installed, the remote users can then access the process software by dialing into the NAS or attaching directly via a cable or DSL modem into the NAS 265. This allows entry into the corporate network where the process software is accessed 266. The process software is transported to the remote user's desktop over the network via tunneling. That is, the process software is divided into packets and each packet including the data and protocol is placed within another packet 267. When the process software arrives at the remote user's desktop, it is removed from the packets, reconstituted and then is executed on the remote user's desktop 268.

A determination is made to see if a VPN for site to site access is required 262. If it is not required, then proceed to exit the process 263. Otherwise, determine if the site to site VPN exists 269. If it does exist, then proceed to 272. Otherwise, install the dedicated equipment required to establish a site to site VPN 270. Then build the large scale encryption into the VPN 271.

After the site to site VPN has been built or if it had been previously established, the users access the process software via the VPN 272. The process software is transported to the site users over the network via tunneling. That is, the process software is divided into packets and each packet including the data and protocol is placed within another packet 274. When the process software arrives at the remote user's desktop, it is removed from the packets, reconstituted and is executed on the site user's desktop 275. Proceed to exit the process 263.

The terminology used herein is for the purpose of describing particular embodiments only and is not intended to be limiting of this disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method, comprising:
generating an electromagnetic parameterized cell (EM Pcell) for a local environment of an integrated circuit (IC) design for a subsequent schematic phase of an electronic design flow, said local environment consisting of base layers of said EM Pcell that are susceptible to electromagnetic (EM) fields generated by an external EM environment;
instantiating a set of parameter values of a parameterized cell (Pcell) to produce a set of Pcell layouts corresponding to a set of local environment layouts;
developing a set of parasitics extracted netlists from said set of local environment layouts and a layout of said external EM environment;
simulating said set of parasitics extracted netlists to provide a set of performance metrics corresponding to each of said set of local environment layouts;
storing said set of parasitics extracted netlists and said set of performance metrics in a design library and creating a symbolic view of said EM Pcell corresponding to said set of local environment layouts; and
accessing said set of performance metrics from said design library during said subsequent schematic phase of said electronic design flow, when said symbolic view of said EM Pcell is displayed to a designer by a user interface.

2. The method of claim 1, said external EM environment including at least one of:
at least one of a basic device and an interconnect in an interconnect layer of said EM Pcell;
at least one of a basic device and an interconnect in an interconnect layer of a neighboring cell of said EM Pcell;
at least one of a basic device and a hierarchical device in base layers of a neighboring cell of said EM Pcell;
said basic device including any of a diode, a transistor, a contact, a capacitor, an inductor, and a resistor, said interconnect including any of a via and a wire, and said hierarchical device including at least two basic devices.

3. The method of claim 1, said set of performance metrics including any of: a set of signal propagation delays, a set of rise and fall times, a set of signal skews, a set of power consumptions, a set of power losses, and a set of frequency domain parameters.

4. The method of claim 1 further comprising flattening each of said set of local environment layouts to develop said set of parasitics extracted netlists.

5. The method of claim 1, further comprising mapping each of nominal, best, and worst case of performance metric values to an input range of said set of parameter values of said Pcell.

6. The method of claim 5 further comprising sweeping said input range of said parameter values of said Pcell to provide a sweep of said performance metric values that is stored, and generating a display of said sweep on a user interface for review by a designer.

7. The method of claim 6 further comprising determining from said sweep, one of said input range of said set of parameter values that yields an optimal performance metric value that approximates a sign-off value of said performance metric for said IC design.

8. A computer system, comprising:
a memory of an integrated circuit (IC) design library for a suite of software design tools that stores parasitics extracted netlists and performance metrics of an electromagnetic parameterized cell (EM Pcell); and
a processor for said suite of software design tools that:
generates said EM Pcell for a local environment of an IC design for a subsequent schematic phase of an electronic design flow, said local environment consisting of base layers of said EM Pcell that are susceptible to electromagnetic (EM) fields generated by an external EM environment;
instantiates a set of parameter values of a parameterized cell (Pcell) to produce a set of Pcell layouts corresponding to a set of local environment layouts;
develops a set of parasitics extracted netlists from said set of local environment layouts and a layout of said external EM environment;
simulates said set of parasitics extracted netlists to provide a set of performance metrics corresponding to each of said set of local environment layouts;
creates a symbolic view of said EM Pcell corresponding to said set of local environment layouts; and
accesses said set of performance metrics from said design library during said subsequent schematic phase of said electronic design flow, when said symbolic view of said EM Pcell is displayed to a designer by a user interface.

9. The computer system of claim 8, said external EM environment including at least one of:
at least one of a basic device and an interconnect in an interconnect layer of said EM Pcell;
at least one of a basic device and an interconnect in an interconnect layer of a neighboring cell of said EM Pcell;
at least one of a basic device and a hierarchical device in base layers of a neighboring cell of said EM Pcell;
said basic device including any of a diode, a transistor, a contact, a capacitor, an inductor, and a resistor, said interconnect including any of a via and a wire, and said hierarchical device including at least two basic devices.

10. The computer system of claim 8, said set of performance metrics including any of: a set of signal propagation delays, a set of rise and fall times, a set of signal skews, a set of power consumptions, a set of power losses, and a set of frequency domain parameters.

11. The computer system of claim 8, said process further flattening each of said set of local environment layouts to develop said set of parasitics extracted netlists.

12. The computer system of claim 8, said processor further mapping each of nominal, best, and worst case of performance metric values to an input range of said set of parameter values of said Pcell.

13. The computer system of claim 12, said processor yet further sweeping said input range of said set of parameter values of said Pcell to provide a sweep of said performance metric values that is stored, and generating a display of said sweep on a user interface for review by a designer.

14. A computer program product for improving computational efficiency and accuracy of an electronic design flow of a cell-based integrated circuit (IC) design, the computer program product comprising a computer readable storage medium having program code embodied therewith, the program code being readable/executable by a computer to perform a method comprising:
generating an electromagnetic parameterized cell (EM Pcell) for a local environment of an IC design for a subsequent schematic phase of an electronic design flow, said local environment consisting of base layers of said EM Pcell that are susceptible to electromagnetic (EM) fields generated by an external EM environment;
instantiating a set of parameter values of a parameterized cell (Pcell) to produce a set of Pcell layouts corresponding to a set of local environment layouts;
developing a set of parasitics extracted netlists from said set of local environment layouts and a layout of said external EM environment;
simulating said set of parasitics extracted netlists to provide a set of performance metrics corresponding to each of said set of local environment layouts;
storing said set of parasitics extracted netlists and said set of performance metrics in a design library and creating a symbolic view of said EM Pcell corresponding to said set of local environment layouts; and
accessing said set of performance metrics from said design library during said subsequent schematic phase of said electronic design flow, when said symbolic view of said EM Pcell is displayed to a designer by a user interface.

15. The computer program product of claim 14, said external EM environment including at least one of:
at least one of a basic device and an interconnect in an interconnect layer of said EM Pcell;
at least one of a basic device and an interconnect in an interconnect layer of a neighboring cell of said EM Pcell;
at least one of a basic device and a hierarchical device in base layers of a neighboring cell of said EM Pcell;
said basic device including any of a diode, a transistor, a contact, a capacitor, an inductor, and a resistor, said interconnect including any of a via and a wire, and said hierarchical device including at least two basic devices.

16. The computer program product of claim 14, said set of performance metrics including any of: a set of signal propagation delays, a set of rise and fall times, a set of signal skews, a set of power consumptions, a set of power losses, and a set of frequency domain parameters.

17. The computer program product of claim 14, said method further comprising flattening each of said set of local environment layouts to develop said set of parasitics extracted netlists.

18. The computer program product of claim 14, said method further comprising mapping each of nominal, best, and worst case of performance metric values to an input range of said set of parameter values of said Pcell.

19. The computer program product of claim 14, said method further comprising sweeping said input range of said set of parameter values of said Pcell to provide a sweep of said performance metric values that is stored, and generating a display of said sweep on a user interface for review by a designer.

20. The computer program product of claim 14, said method further comprising determining from said sweep, one of said input range of said parameter values that yields an optimal performance metric value that approximates a sign-off value of said performance metric for said IC design.
